(19) United States
(12) Patent Application Publication
(10) Pub. No.: US 2008/0007420 A1
(43) Pub. Date: Jan. 10, 2008

(54) REMOTE CONTROL DEVICE

(75) Inventors: Lawrence E. Meyers, Fountain Hills, AZ (US); John Florence, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: TALKING DOG, LP, Scottsdale, AZ (US)

(21) Appl. No.: 11/768,158

(22) Filed: Jun. 25, 2007

Related U.S. Application Data
(60) Provisional application No. 60/816,237, filed on Jun. 23, 2006.

(51) Int. Cl. G05B 19/02

(52) U.S. Cl. 340/825.22

(57) ABSTRACT

The present invention provides for a simplified remote control device for use by small children and others without supervision or assistance. Each button of a remote control device may be programmed to correspond to a specific track or chapter of a DVD or to a specific channel for a television. A menu card that slides in and out of a slot behind the remote control unit's buttons may be utilized to change the appearance of the remote control unit, such that the appearance may be tailored to the content of specific DVDs and the like. Other embodiments of the present invention provide for a simplified remote control device that may be used by seniors, or used by personnel in specialized settings such as sports bars.

### CROSS-REFERENCE TO RELATED APPLICATIONS

This application claims priority to and benefit of U.S. Provisional Application No. 60/816,237, entitled “Remote Control Device” and filed on Jun. 23, 2006.

### FIELD OF INVENTION

The present invention relates, generally, to remote control devices, and more particularly to a system and methods for a new and improved remote control device that is easy for young children and others to use without supervision or assistance.

### BACKGROUND OF THE INVENTION

Remote control devices have been in existence for many years for controlling various devices, including televisions and stereos. More recently, with the advent of video cassette recorders (VCRs) and digital video disc (DVD) players, remote control devices have also been developed for these devices as well. Typically, the remote control device is tailored to the specific device (i.e., TV, VCR, DVD player, etc.) and are designed for use by adults, teenagers, and older children. When a smaller child, for example a 2, 3, or 4 year old child, wants to use a DVD player or other similar device, an adult must be present to control the use of the DVD player. If the child wants to re-play a scene or otherwise manipulate the DVD player with a remote control device, then the child must rely on the adult to operate the remote control device or otherwise control the DVD player to carry out the desired action.

As a result, adults have to spend a lot of time operating a DVD player, even when they are not watching the DVD, so that a small child may be able to watch the DVD. Accordingly, it is desirable to create a remote control device that may be utilized in a safe manner by a small child, such as a 2, 3, or 4 year old, and others, without supervision or assistance.

### BRIEF DESCRIPTION OF THE DRAWINGS

A more complete understanding of the present invention may be derived by referring to the detailed description and claims when considered in connection with the drawing Figures, where like reference numbers refer to similar elements throughout the Figures, and:

FIG. 1 illustrates a remote control device in accordance with an embodiment of the present invention;

FIG. 2 illustrates a left view of a remote control device in accordance with an embodiment of the present invention;

FIG. 3 illustrates a top view of a remote control device in accordance with an embodiment of the present invention;

FIG. 4 illustrates a right view of a remote control device in accordance with an embodiment of the present invention;

FIG. 5 illustrates a front view of a remote control device in accordance with an embodiment of the present invention;

FIG. 6 illustrates a bottom view of a remote control device in accordance with an embodiment of the present invention;

FIG. 7A illustrates a remote control device in accordance with an embodiment of the present invention; and

FIG. 7B illustrates an opened remote control device in accordance with an embodiment of the present invention.

### DETAILED DESCRIPTION

The detailed description of exemplary embodiments of the invention herein makes reference to the accompanying drawings, which show exemplary embodiments by way of illustration and the best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional features of remote control devices and other functional aspects of the present invention may not be described in detail herein. It should be noted that many alternative or additional functional relationships or physical connections may be present in a practical system.

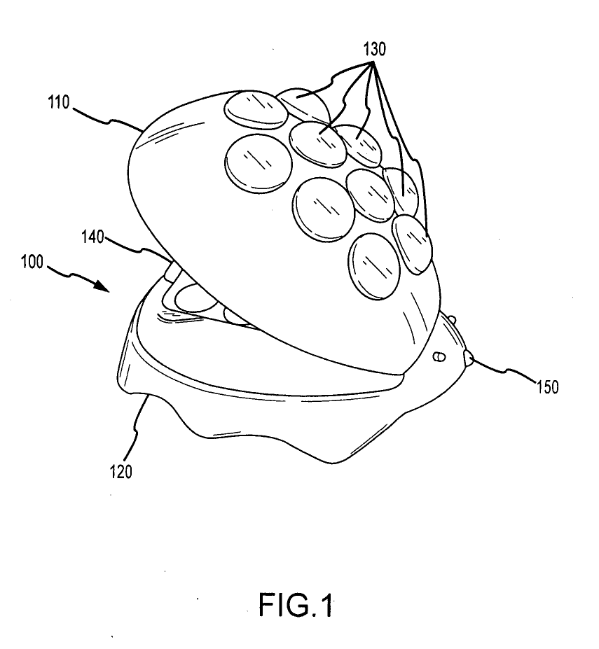

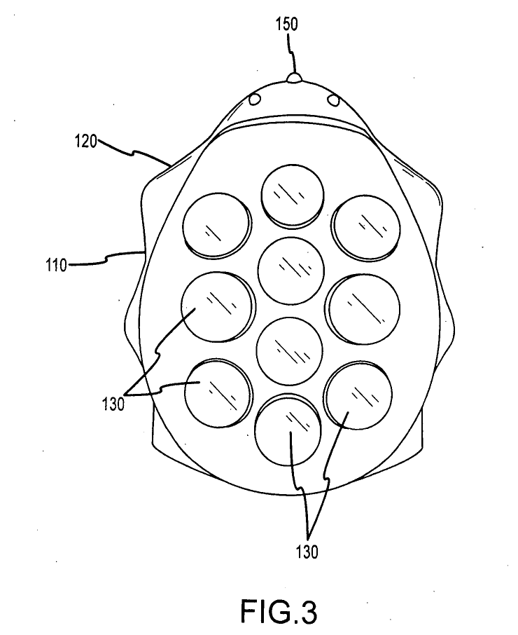

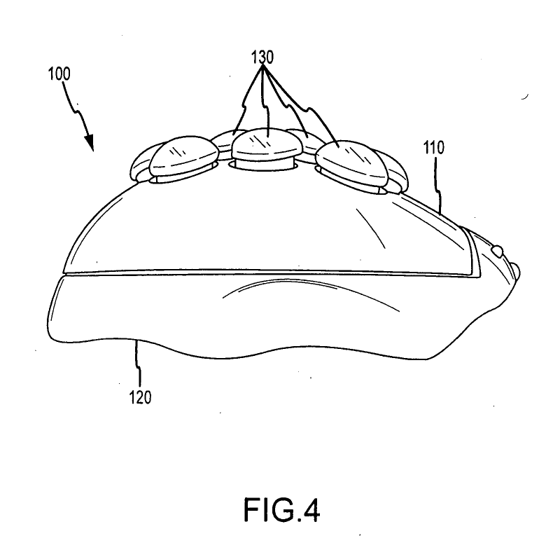

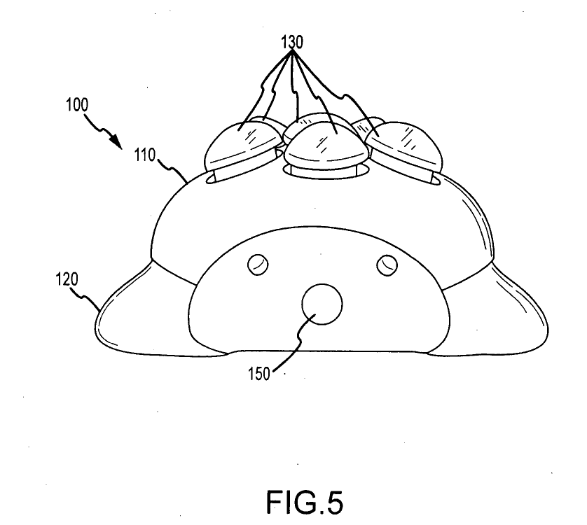

With reference to FIGS. 1-7B, a remote control device 100 according to various embodiments of the present invention includes a universal remote control unit that works with any DVD player and contains a small number of buttons 130 (typically 10 buttons or less). Remote control device 100 includes a shell 110, a base 120, a menu insert 140, and a signal sender 150. The universal remote control unit may be made from a soft plastic, with no sharp edges, in order to provide for safe use by a small child. In addition, the unit may be brightly colored so that it is more attractive to small children.

In accordance with one embodiment of the present invention, shell 110 may open such that menu insert 140 may be placed underneath buttons 130. In this manner, the appearance of the buttons may be changed by using different menu inserts that contain different images. Base 120 may be rubber coated so that it is softer and easy to grip and handle. Signal sender 150 may be an infrared signal sender or other signal sender as is known in the art.

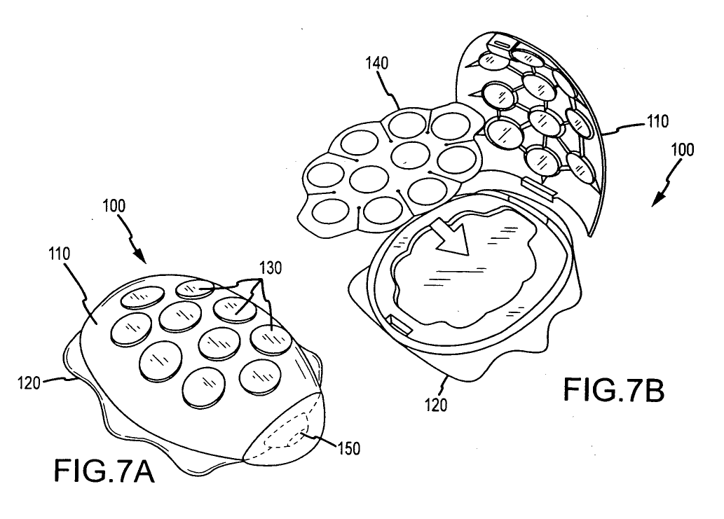

Buttons 130 for the remote control unit may comprise oversized buttons to facilitate ease of use by small children. In accordance with one embodiment of the present invention, each of the buttons may correspond to a separate track or chapter for a DVD, such that depressing a button will result in the DVD player jumping to a specific section of the DVD. For example, a DVD, in accordance with an embodiment of the present invention, may contain content for zoo animals. Each track or chapter may correspond to a separate zoo animal (e.g., cheetah) or to a separate group of zoo animals (e.g., monkeys). With reference to FIGS. 1 and 7B, a menu image insert 140 may be utilized such that the corresponding button for a particular track may contain an illustration of the animal that corresponds to a particular channel or track of an authored DVD. Menu insert 140 may be placed between shell 110 and base 120, such that the menu insert is held in place when the remote control device is shut. When it is desired to view cheetahs, a small child only has to press the button with an illustration of a cheetah, and the remote control unit will signal the DVD player to jump to the DVD chapter with the cheetah content. Similarly, the small child may use the remote control unit to jump to other sections of the DVD by pressing the illustrated button that corresponds to a different animal that is associated with a different chapter of the DVD. In this manner, a small child will be able to use the remote control unit to control the DVD player.

In accordance with an embodiment of the present invention, EPROMs or other similar type of memory may be programmed to control the remote control unit. In accordance with another embodiment of the present invention, a DVD or other device that contains content may be authored such that the DVD is programmed to allow the remote control unit to jump to specific tracks/chapters by depressing a single button on the remote control unit. In accordance with yet another embodiment of the present invention, a combination of the remote control unit (e.g., EPROM) and the DVD may be programmed to allow the remote control unit to jump to specific tracks/chapters by depressing a single button on the remote control unit. The EPROM may be programmed such that depressing a specific button will cause the remote control unit to send a signal to the DVD player to jump directly to the track or chapter that corresponds to that specific button, and thus bypassing any menus, such as the main or top menu of a DVD.

In accordance with an embodiment of the present invention, a DVD may be authored to work with the remote control device of the present invention. In accordance with one embodiment, a DVD may be authored in the following manner. An image, containing a complete compilation of data is burned on the DVD. Codes are added that delineate the beginning and end of each chapter of data. For example, one chapter may correspond to data for a particular animal such as a tiger, while another chapter may correspond to a different animal such as a wolf. These codes are used by the remote control device to determine the start of a particular chapter of data.

In accordance with one embodiment of the present invention, there is one chapter of data on each track of the DVD. In accordance with another embodiment of the present invention, there may be more than one chapter of data on a track of the DVD. In accordance with another embodiment of the present invention, one chapter of data may cross multiple tracks of the DVD.

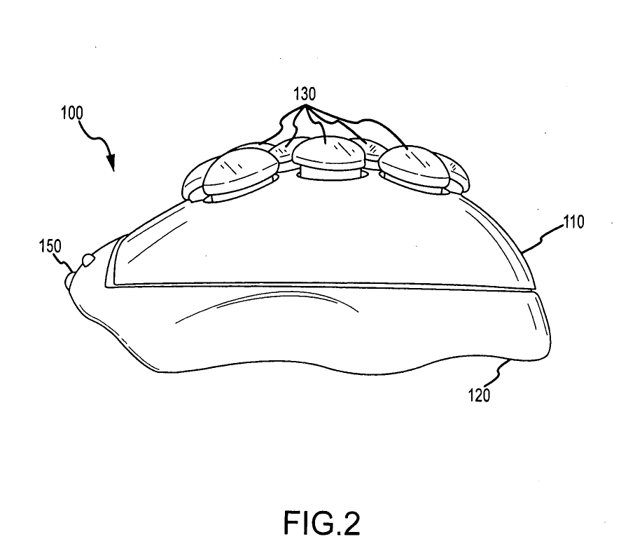

In accordance with an exemplary embodiment of the present invention, a menu card may be utilized to change the look of the remote control by changing the illustrations for the buttons of the remote control device. With reference to FIG. 2, for example, if the buttons are made of a clear material, such as plastic, a menu card may be slipped into a slot located in the remote control device, such that the illustrations on the menu card are aligned with the remote control buttons and change the look of the remote control device. In accordance with an aspect of the present invention, menu cards may be utilized that are unique to each DVD title, thus allowing the remote control device to be specific to the content on a particular DVD.

In accordance with this embodiment of the present invention, thumbnail photos may be utilized on the menu card that are sequenced to match the different tracks of the DVD. Thus, it will be appreciated, that a small child may be able to navigate the DVD contents without adult supervision. In accordance with this exemplary embodiment of the present invention, it may be desirable to limit the number of buttons, for example to ten or less, such that the remote control unit is less cluttered and easier to use.

In accordance with another aspect of the present invention, the remote control unit may be programmed for a specific DVD player by utilizing the buttons of the remote control unit. This may be carried out in a number of ways, including pressing a button that is hidden in a battery compartment 600 of the remote control device. Once this hidden button is pressed, the buttons on the remote control device correspond to numerical values for programming the remote control device for use with a particular model of DVD player (e.g., universal codes). In accordance with one embodiment of the present invention, this particular mode of operation for the remote control unit may be carried out by a separate EPROM from the EPROM described above. For ease of manufacturing, the EPROMs may be located on the same board within the remote control unit. Once the remote control device is programmed for a particular DVD player, the hidden button may be depressed again, and the remote control buttons will return to their function of corresponding to specific chapters or tracks of the DVD as described above. Thus, control will be returned to the EPROM that controls the mode where each remote control unit button corresponds to a different DVD chapter of data.

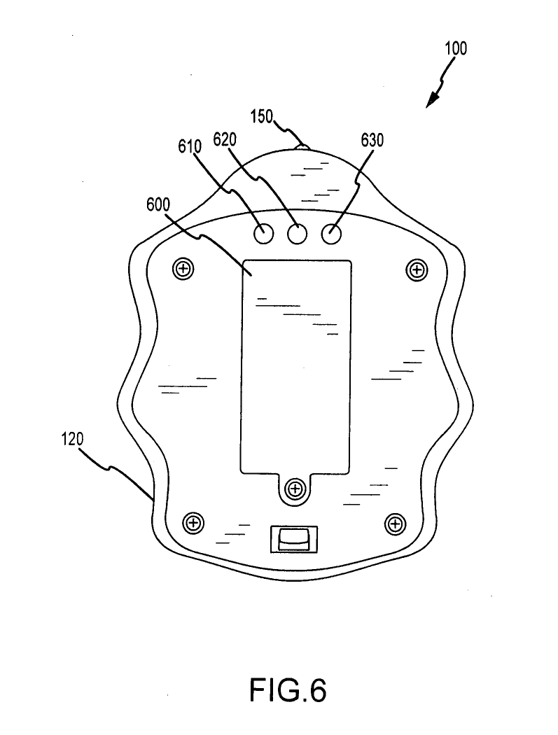

With reference to FIG. 6, in accordance with an embodiment of the present invention, remote control unit 100 may include a power button 620, and two or more buttons 620, 630 for controlling two or more DVD players or other video players or televisions and the like.

One embodiment of the present invention supports use by seniors for controlling simplified TV channels. In accordance with this embodiment, the buttons of the remote control device may be programmed to correspond to different television channels. By utilizing an illustrated menu card as described above, each button may have a different illustration that corresponds to a particular television channel. For example, “CNN” may be used to correspond to the CNN channel, and a picture of animals may be used to correspond to the animal planet channel.

Another embodiment of the present invention facilitates children controlling simplified TV channels. In yet another embodiment of the present invention, the remote control device may be used in sports bars to control sports feed from specialized systems, such as Direct TV boxes and the like.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” Further, no element described herein is required for the practice of the invention unless expressly described as “essential” or “critical.”

We claim:

1. A remote control unit for a video player that plays a video disc with a plurality of chapters of data, the remote control unit comprising:
a shell containing a plurality of buttons, wherein each of the plurality of buttons is associated with one of the chapters of data;
a base connected to the shell;
a menu insert containing a plurality of images, wherein the menu insert is positioned between the shell and the base, such that the plurality of images align with the plurality of buttons, and each of the images corresponds to at least one of the chapters of data;
a programmable memory, wherein the programmable memory is configured to send a signal to the video player when one of the plurality of buttons is depressed, wherein the sent signal corresponds to the chapter of data that is associated with the depressed button.
